(19) United States
(12) Patent Application Publication
(10) Pub. No.: US 2007/0097041 A1
(43) Pub. Date: May 3, 2007

(54) DISPLAY DEVICE AND DRIVING METHOD THEREOF

(75) Inventors: Kyong-Tae PARK, Uijeongbu-si, Gyeonggi-do (KR); Chun-Seok KO, Hwaseong-si, Gyeonggi-do (KR); Nam-Deog KIM, Yongin-si, Gyeonggi-do (KR); Si-Duk SUNG, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/553,796

(22) Filed: Oct. 27, 2006

(30) Foreign Application Priority Data
Oct. 28, 2005 (KR) 10-2005-0102586
Oct. 28, 2005 (KR) 10-2005-0102587

(51) Int. Cl. G09G 3/30

(52) U.S. Cl. 345/77

(57) ABSTRACT

A display device includes: a plurality of pixels comprising normal pixels and sample pixels; a plurality of sensing units which sense luminance of the sample pixels and generate sensing signals based on the sensed luminance; a gray voltage generator which generates a plurality of reference gray voltages having values depending on the sensing signals; and a data driver which generates normal data voltages for the normal pixels and sample data voltages for the sample pixels.

This application claims priority to Korean Patent Applications Nos. 10-2005-0102586 and 10-2005-0102587, filed on Oct. 28, 2005 and Oct. 28, 2005, respectively, and all the benefits accruing therefrom under 35 U.S.C. §119, the contents of which in their entirety are herein incorporated by reference.

### BACKGROUND OF THE INVENTION

(a) Field of the Invention

The present invention relates to a display device and a driving method thereof.

(b) Description of Related Art

Recently, flat panel displays have been actively considered as substitutes for conventional cathode ray tubes (“CRTs”). In particular, an organic light emitting diode (“OLED”) display has been focused on as a next-generation flat panel display due to its superior luminance and viewing angle characteristics.

Generally, an active matrix flat panel display includes a plurality of pixels arranged in a matrix and displays images by controlling the luminance of the pixels based on given luminance information. An OLED display is a self-emissive display device that displays images by electrically exciting light emitting organic material. Further, the OLED display has low power consumption, wide viewing angle, and fast response time, thereby being advantageous for displaying motion images.

A pixel of an OLED display includes an OLED and a driving thin film transistor (“TFT”). The TFT includes polysilicon or amorphous silicon. A polysilicon TFT has several advantages, but it also has disadvantages such as the complexity of manufacturing polysilicon thin films, thereby increasing the manufacturing cost. In addition, it is difficult to make a large sized OLED display employing polysilicon TFTs.

On the contrary, an amorphous silicon TFT is easily applicable to a large sized OLED display and is manufactured using less process steps than the polysilicon TFT.

The OLEDs emit red, green and blue lights, and the OLEDs have different emission efficiencies and different degrees of degradation depending on the color of the emission. In particular, the OLED emitting blue light has a lifetime shorter than the other OLEDs (e.g., OLEDs emitting red or green light) such that the white balance is broken to display yellowish images as time elapses. In addition, the OLEDs emitting red or blue light may also degrade as time elapses.

### BRIEF SUMMARY OF THE INVENTION

A display device according to an exemplary embodiment of the present invention includes: a plurality of pixels comprising normal pixels and sample pixels; a plurality of sensing units which sense luminance of the sample pixels and generate sensing signals based on the sensed luminance; a gray voltage generator which generates a plurality of reference gray voltages having values depending on the sensing signals; and a data driver which generates normal data voltages for the normal pixels and sample data voltages for the sample pixels.

The display device may further include a signal controller which generates normal image signals for the normal pixels and sample image signals for the sample pixels based on input image signals for the normal pixels and controls the gray voltage generator, wherein the data driver converts the normal image signals into the normal data voltages and the sample image signals into the sample data voltages.

The sample image signals may include average image signals obtained by averaging the normal image signals and reference image signals having fixed values.

The signal controller may include a signal averaging unit which averages the normal image signals to generate the average image signals.

The average image signals may be obtained by averaging the normal image signals for a limited number of the normal pixels or by averaging the normal image signals having a predetermined range of grays.

Total grays that can be represented by the normal image signals may be grouped into a plurality of gray groups, the predetermined range of grays may be included in one of the gray groups, and the number of the normal image signals representing grays in the one of the gray groups may be equal to or larger than the number of the normal image signals having grays in each of other gray groups.

The signal controller may further include a counter which counts the number of the normal image signals having grays in each of the gray groups. The numbers of grays in at least two of the gray groups are different from each other.

The reference image signals may be supplied to the data driver less frequently than the average image signals.

The display device may further include a sensing signal processor which processes the sensing signals that represent the luminance of the sample pixels according to the reference image signals.

The signal controller may generate a gray control signal determining values of the reference gray voltages based on an output of the sensing signal processor. The signal controller may further include a lookup table which stores the gray control signal as a function of the output of the sensing signal processor.

The sample pixels include three sample pixels which emit different-colored lights, which may be simultaneously supplied with the sample data voltages or sequentially supplied with the sample data voltages from a single data line.

The normal pixels may display images and the sample pixels may not participate in displaying images.

A method of driving a display device according an exemplary embodiment of the present invention includes: supplying normal data voltages to normal pixels to display an image; supplying a first sample data voltage obtained from the normal data voltages to a sample pixel to emit light; supplying a second sample data voltage having a fixed value to the sample pixel to emit light; determining values of gray voltages based on a luminance of the sample pixel according to the second sample data voltage; and generating the normal data voltages from the gray voltages.

The supply of the first sample data voltage may include: averaging normal image signals to generate an average image signal; converting the average image signal into the first sample data voltage; and applying the first sample data voltage to the sample pixel, wherein the normal data voltages are converted from the normal image signals.

The determination of the values of the gray voltages may include: sensing the luminance of the sample pixel; generating a sensing signal based on the sensed luminance of the sample pixel; and determining the values of the gray voltages based on the sensing signal.

A display panel according an exemplary embodiment of the present invention includes: a plurality of normal pixels displaying images; a plurality of sample pixels spaced apart from the normal pixels; a plurality of sensing units which sense luminance of the sample pixels; a plurality of scanning lines connected to the normal pixels and the sample pixels; and a plurality of data lines connected to the normal pixels and the sample pixels.

The scanning lines may include a plurality of normal scanning lines connected to the normal pixels and a sample scanning line connected to the sample pixels. The sample pixels are connected to different data lines.

The data lines may include a plurality of normal data lines connected to the normal pixels and a sample data line connected to the sample pixels.

The normal pixels may be disposed in a display area and the sample pixels are disposed outside of the display area.

### BRIEF DESCRIPTION OF THE DRAWINGS

The present invention will become more apparent by describing exemplary embodiments thereof in more detail with reference to the accompanying drawing in which:

FIG. 1 is a block diagram of an OLED display according to an exemplary embodiment of the present invention;

FIG. 2 is a block diagram of an OLED display according to another exemplary embodiment of the present invention;

FIG. 3 is an equivalent circuit schematic diagram of a pixel of an OLED display according to an exemplary embodiment of the present invention;

FIG. 4 is a cross-sectional view of an organic light emitting element and a driving transistor shown in FIG. 3;

FIG. 5 is a schematic diagram of an organic light emitting element according to an exemplary embodiment of the present invention;

FIG. 6 is a block diagram of a sample image signal generator of an OLED display according to an exemplary embodiment of the present invention;

FIG. 7 is a block diagram of a sample image signal generator of an OLED display according to another exemplary embodiment of the present invention;

FIG. 8 shows waveforms of various signals used in an OLED display according to an exemplary embodiment of the present invention; and

FIG. 9 is a graph illustrating a gray control signal of an OLED display according to an exemplary embodiment of the present invention.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these exemplary embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, exemplary embodiments of the present invention should not be construed as being limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

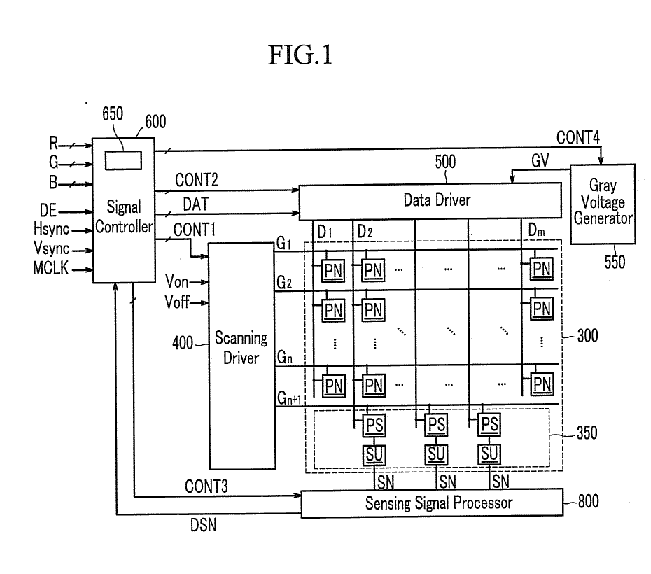

Referring to FIGS. 1, 2 and 3, an organic light emitting diode (“OLED”) display according to exemplary embodiments of the present invention will be described in more detail.

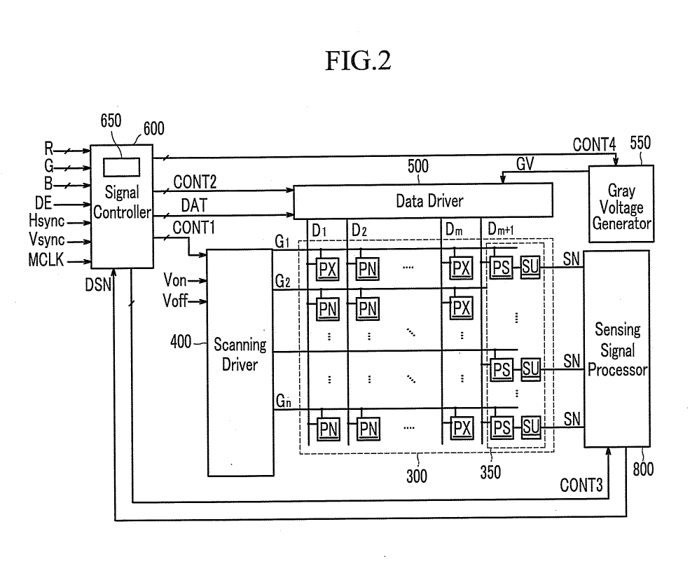

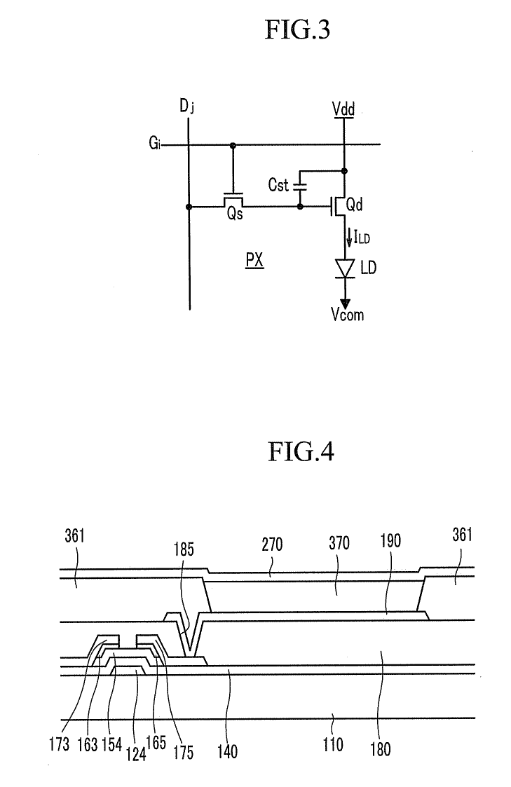

FIG. 1 is a block diagram of an OLED display according to an exemplary embodiment of the present invention. FIG. 2 is a block diagram of an OLED display according to another exemplary embodiment of the present invention. FIG. 3 is an equivalent circuit schematic diagram of a pixel of an OLED display according to an exemplary embodiment of the present invention.

Referring to FIGS. 1 and 2, an OLED display according to exemplary embodiments include a display panel 300, a scanning driver 400, a data driver 500, a sensor signal processor 700, a gray voltage generator 550 and a signal controller 600.

The display panel 300 includes a plurality of signal lines G₁-Gₙ or Gₙ₊₁ and D₁-Dₘ or Dₘ₊₁, a plurality of voltage lines (not shown), a plurality of normal pixels PN, and a luminance sensor 350. The luminance sensor 350 includes a plurality of sample pixels PS and a plurality of sensing units SU.

The signal lines shown in FIG. 1 include a plurality of scanning lines G₁-Gₙ₊₁ and a plurality of data lines D₁-Dₘ. The scanning lines G₁-Gₙ₊₁, which transmit scanning signals, include a plurality of normal scanning lines G₁-Gₙ and a sample scanning line Gₙ₊₁. The data lines D₁-Dₘ transmit data voltages including normal data voltages for the normal pixels PN and sample data voltages for the sample pixels PS.

The signal lines shown in FIG. 2 include a plurality of scanning lines G₁-Gₙ and a plurality of data lines D₁-Dₘ₊₁. The scanning lines G₁-Gₙ, transmit scanning signals. The data lines D₁-Dₘ₊₁ include a plurality of normal data lines D₁-Dₘ transmitting normal data voltages for the normal pixels PN and a sample data line Dₘ₊₁ transmitting sample data voltages for the sample pixels PS.

The scanning lines G₁-Gₙ₊₁ extend substantially in a row direction and substantially parallel to each other, while the data lines D₁-Dₘ₊₁ extend substantially in a column direction and substantially parallel to each other.

The voltage lines may transmit a driving voltage Vdd (FIG. 3).

Referring to FIG. 1, the normal pixels PN are arranged in a matrix and connected to the normal scanning lines G₁-Gₙ and the data lines D₁-Dₘ. The sample pixels PS are connected to the sample scanning line Gₙ₊₁ and some of the data lines D₁-Dₘ.

Referring to FIG. 2, the normal pixels PN are arranged in a matrix and connected to the scanning lines G₁-Gₙ and the normal data lines D₁-Dₘ, and. The sample pixels PS are connected to the sample data line Dₘ₊₁ and some of the scanning lines G₁-Gₙ. The normal pixels PN may be exposed to display images, while the sample pixels PS may be covered so as to not contribute to the display of images.

The normal pixels PN and the sample pixels PS have substantially the same internal configuration, and they will be commonly referred to as pixels and denoted as PX.

Referring to FIG. 3, each of the pixels PX, for example, a pixel PX connected to a scanning line Gᵢ (where i=1, 2, . . . , n+1) and a data line Dⱼ (where j=1, 2, . . . , m+1) includes a switching transistor Qs, a driving transistor Qd, a capacitor Cst and an organic light emitting element LD.

The switching transistor Qs has a control terminal, an input terminal and an output terminal. The control terminal is connected to the scanning line Gᵢ, the input terminal is connected to the data line Dⱼ, and the output terminal is connected to the driving transistor Qd.

The driving transistor Qd also has a control terminal, an input terminal and an output terminal. The control terminal is connected to the output terminal of the switching transistor Qs, the input terminal is connected to the driving voltage Vdd, and the output terminal is connected to the organic light emitting element LD.

The capacitor Cst is connected between the control terminal and the input terminal of the driving transistor Qd.

The organic light emitting element LD may be an organic light emitting diode (“OLED”) and has an anode connected to the output terminal of the driving transistor Qd and a cathode connected to a common voltage Vcom. The organic light emitting element LD may emit light representing one of primary colors such as red, green and blue. However, the organic light emitting member LD of some of the pixels PX may emit white light.

Otherwise, the organic light emitting elements LD of all of the pixels PX may emit white light, and in this case at least some of the pixels PX may further include a color filter (not shown) that converts the white light emitted from the organic light emitting elements LD into a primary color light.

Hereinafter, the pixels PX that include organic light emitting elements LD emitting red light, green light and blue light are referred to as red, green and blue pixels, respectively. The normal pixels PN may include a plurality of sets of a red normal pixel, a green normal pixel and a blue normal pixel. The sample pixels PS may include a set of a red sample pixel, a green sample pixel and a blue sample pixel. However, the sample pixels PS may include two or more sets of red, green and blue sample pixels PS. In this case, the number of the sample scanning lines Gₙ₊₁ or the number of the sample data lines Dₘ₊₁ may also be two or more.

The switching transistor Qs and the driving transistor Qd are n-channel field effect transistors (“FETs”) including amorphous silicon or polysilicon. However, at least one of the transistors Qs and Qd may be a p-channel FET. The connection relationship among the transistors Qs and Qd, the capacitor Cst and the OLED LD may be interchanged.

Referring again to FIGS. 1 and 2, each of the sensing units SU is disposed near a sample pixel PS and coupled to the sensing signal processor 800. The sensing unit SU senses the luminance of the sample pixel PS and generates a sensing signal SN corresponding to the sensed luminance. The sensing unit SU may include a photodiode (not shown) and may further include a photo transistor for amplifying the sensing signal SN.

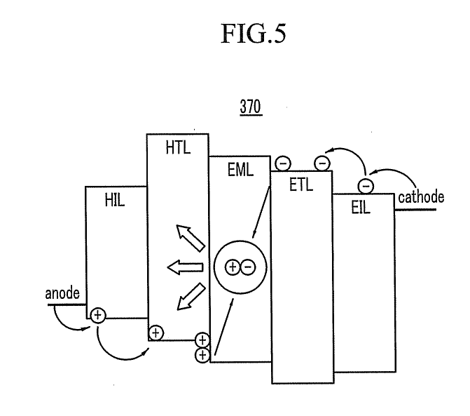

Now, a structure of an organic light emitting element LD and a driving transistor Qs shown in FIG. 3 will be described in more detail with reference to FIGS. 4 and 5.

FIG. 4 is a cross-sectional view of the exemplary embodiment of the organic light emitting element LD and driving transistor Q_{D} shown in FIG. 3. FIG. 5 is a schematic diagram of an organic light emitting element according to an exemplary embodiment of the present invention.

A control electrode 124 is formed on an insulating substrate 110. The control electrode 124 is preferably made of a Al containing metal such as Al and an Al alloy, a Ag containing metal such as Ag and a Ag alloy, a Cu containing metal such as Cu and a Cu alloy, a Mo containing metal such as Mo and a Mo alloy, Cr, Ti or Ta. The control electrode 124 may have a multi-layered structure including two films having different physical characteristics. In exemplary embodiments, one of the two films is made of a metal having low resistivity including an Al containing metal, a Ag containing metal, and a Cu containing metal for reducing signal delay or voltage drop. The other film is made of material such as a Mo containing metal, Cr, Ta or Ti, which has good physical, chemical and electrical contact characteristics with other materials such as indium tin oxide (“ITO”) or indium zinc oxide (“IZO”). Suitable examples of the combination of the two films are a lower Cr film and an upper Al (alloy) film and a lower Al (alloy) film and an upper Mo (alloy) film. However, the control electrode 124 may be made of various metals or conductors. The lateral sides of the control electrode 124 are inclined relative to a surface of the substrate 110, and the inclination angle thereof ranges about 30 degrees to about 80 degrees.

An insulating layer 140, preferably made of silicon nitride (“SiNx”), is formed on the control electrode 124.

A semiconductor 154 that may be made of hydrogenated amorphous silicon (abbreviated to “a-Si”) or polysilicon is formed on the insulating layer 140, and a pair of ohmic contacts 163 and 165 that may be made of silicide or n+ hydrogenated a-Si heavily doped with n type impurity such as phosphorous are formed on the semiconductor 154. The lateral sides of the semiconductor 154 and the ohmic contacts 163 and 165 are inclined relative to the surface of the substrate 110, and the inclination angles thereof are preferably in a range of about 30 degrees to about 80 degrees.

An input electrode 173 and an output electrode 175 are formed on the ohmic contacts 163 and 165, respectively, and the insulating layer 140. The input electrode 173 and the output electrode 175 are preferably made of a refractory metal such as Cr, Mo, Ti, Ta or alloys thereof. However, they may have a multilayered structure including a refractory metal film (not shown) and a low resistivity film (not shown). Good example of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. Like the control electrode 124, the input electrode 173 and the output electrode 175 have inclined edge profiles, and the inclination angles thereof range about 30 degrees to about 80 degrees.

The input electrode 173 and the output electrode 175 are separated from each other and disposed opposite each other with respect to the control electrode 124. The control electrode 124, the input electrode 173 and the output electrode 175, as well as the semiconductor 154, form a TFT serving as a driving transistor Qd having a channel located between the input electrode 173 and the output electrode 175.

The ohmic contacts 163 and 165 are interposed only between the underlying semiconductor 154 and the overlying electrodes 173 and 175 thereon and reduce the contact resistance therebetween. The semiconductor 154 includes an exposed portion, which is not covered with the input electrode 173 and the output electrode 175 and corresponds to the channel located between the input electrode 173 and the output electrode 175.

A passivation layer 180 is formed on the electrodes 173 and 175, the exposed portion of the semiconductor 154 and the insulating layer 140. The passivation layer 180 may be made of an inorganic insulator or an organic insulator and it may have a flat top surface. Examples of the inorganic insulator include silicon nitride and silicon oxide. The organic insulator may have photosensitivity and dielectric constant less than about 4.0. The passivation layer 180 may include a lower film of an inorganic insulator and an upper film of an organic insulator such that it uses the excellent insulating characteristics of the organic insulator while the inorganic insulator prevents the exposed portions of the semiconductor 154 from being damaged. The passivation layer 180 has a contact hole 185 exposing the output electrode 175.

A pixel electrode 190 is formed on the passivation layer 180. The pixel electrode 190 is physically and electrically connected to the output electrode 175 through the contact hole 185. In exemplary embodiments, the pixel electrode 190 is made of a transparent conductor such as ITO or IZO or a reflective metal such as Ag, Al, or an alloy thereof.

A partition 361 is formed on the passivation layer 180. The partition 361 encloses the pixel electrode 190 to define an opening on the pixel electrode 190 like a bank, and it is made of organic or inorganic insulating material.

An organic light emitting member 370 is formed on the pixel electrode 190 and is confined in the opening enclosed by the partition 361.

Referring to FIG. 5, the organic light emitting member 370 has a multilayered structure including an emitting layer EML and auxiliary layers for improving the efficiency of light emission of the emitting layer EML. The auxiliary layers include an electron transport layer ETL and a hole transport layer HTL for improving the balance of the electrons and holes and an electron injecting layer EIL adjacent to the cathode and a hole injecting layer HIL adjacent to the anode for improving the injection of the electrons and holes, respectively. In alternative exemplary embodiments, the auxiliary layers may be omitted.

A common electrode 270 to which a common voltage Vcom is applied is formed on the organic light emitting member 370 and the partition 361. The common electrode 270 may be made of a reflective metal such as calcium (Ca), barium (Ba), aluminum (Al), or silver (Ag), or other similar substances, or a transparent conductive material such as ITO and IZO.

In a top emission type of OLED display, the pixel electrode 190 is made to be opaque and the common electrode 270 is made to be transparent. In a bottom emission type of OLED display, the pixel electrode 190 and the insulation substrate 110 are made to be transparent and the common electrode 270 is made to be opaque.

A pixel electrode 190, an organic light emitting member 370 and a common electrode 270 form an OLED LD having the pixel electrode 190 as an anode and the common electrode 270 as a cathode, or vice versa depending on the design choices in the construction of the circuit. The OLED LD uniquely emits light of one of primary colors depending on the material of the light emitting member 370. An exemplary set of the primary colors includes red, green and blue and the display of images is realized by the addition of the three primary colors.

Referring to FIGS. 1, 2 and 3 again, the gray voltage generator 550 generates a plurality of reference gray voltages GV related to the luminance of the pixels PX. The reference gray voltages GV may include three sets of reference gray voltages for red, green and blue pixels PX.

The scanning driver 400 is connected to the scanning lines G₁-Gₙ₊₁ of the display panel 300 and synthesizes a high voltage Von for turning on the switching transistors Qs and a low voltage Voff for turning off the switching transistors Qs to generate scanning signals for application to the scanning lines G₁-Gₙ₊₁.

The data driver 500 is connected to the data lines D₁-Dₘ₊₁ of the display panel 300 and applies data voltages generated from the reference gray voltages GV from the gray voltage generator 550 to the data lines D₁-Dₘ₊₁.

The sensing signal processor 800 receives the sensing signals SN from the sensing units SU and processes the sensing signals SN to generate digital sensing signals DSN.

The driving apparatus 400, 500, 550 and 800 may be implemented as integrated circuit (“IC”) chip mounted on the display panel 300 or on a flexible printed circuit (“FPC”) film in a tape carrier package (“TCP”) type, which are attached to the display panel 300. Alternatively, the driving apparatus 400, 500, 550 and 800 may be integrated into the display panel 300 along with the signal lines G₁-Gₙ₊₁ and D₁-Dₘ₊₁ and the transistors Qd and Qs may be thin film transistors (“TFTs”).

The signal controller 600 controls the scanning driver 400, the data driver 500 and the gray voltage generator 550. The signal controller 600 includes a sample image signal generating unit 650 generating sample image signals.

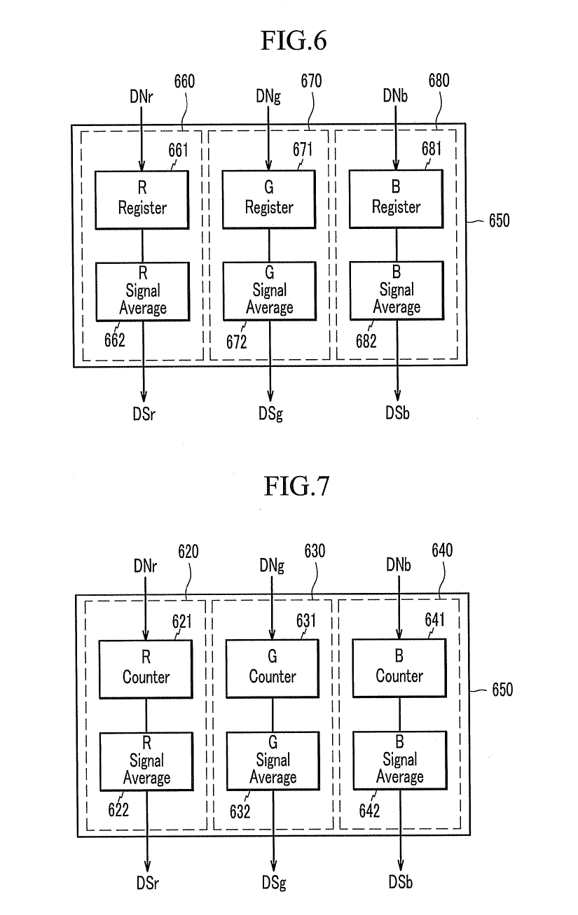

FIG. 6 is a sample image signal generator of an OLED display according to an exemplary embodiment of the present invention.

Referring to FIG. 6, the sample image signal generating unit 650 according to an exemplary embodiment of the present invention includes three sample generators 660, 670 and 680. Each of the sample generators 660, 670 and 680 includes a register 661, 671 or 681 and a signal averaging unit 662, 672 or 682, and is assigned to one of red, green and blue normal image signals DNr, DNg and DNb, respectively. The red, green and blue normal image signals DNr, DNg and DNb are for red, green and blue normal pixels PN, respectively.

Each of the registers 661, 671 and 681 receives normal image signals DNr, DNg and DNb and stores a frame of the normal image signals DNr, DNg and DNb. Each of the signal averaging units 662, 672 and 682 averages the normal image signals DNr, DNg and DNb stored in the registers 661, 671 and 681 to generate an average image signal Dr, Dg and Db for the red, green and blue sample pixels PS, respectively.

The registers 661, 671 and 681 may store normal image signals DNr, DNg and DNb for a limited number of normal pixels PN but not for all of the normal pixels PN. Then, the capacity of the registers 661, 671 and 681 may be reduced and the averaging operation may be simplified.

FIG. 7 is a sample image signal generator of an OLED display according to another exemplary embodiment of the present invention.

Referring to FIG. 7, the sample image signal generating unit 650 according to another exemplary embodiment of the present invention includes three sample generators 620, 630 and 640.

Each of the sample generators 620, 630 and 640 includes a counter 621, 631 or 641 and a signal averaging unit 622, 632 or 642, and is assigned to one of red, green and blue normal image signals DNr, DNg and DNb, respectively. The sample generators 620, 630 and 640 group total grays into a plurality of gray groups and count the number of normal image signals DNr, DNg and DNb having grays belonging to each gray group among the normal image signals DNr, DNg and DNb for a frame. The sample generators 620, 630 and 640 select a gray group having the greatest number of associated normal image signals DNr, DNg and DNb, and average the associated normal image signals DNr, DNg and DNb to generate average image signals DSr, DSg and DSb.

The counters 621, 631 and 641 count the number of normal image signals DNr, DNg and DNb having grays belonging to each gray group and select a gray group having the greatest number of associated normal image signals DNr, DNg and DNb.

The signal averaging units 622, 632 and 642 average the normal image signals DNr, DNg and DNb having grays included in the selected gray group to generate average image signals Dr, Dg and Db.

The number of the gray groups and the range of each of the gray groups may be varied, for example, depending on the frequency of the grays of the normal image signals DNr, DNg and DNb.

For example, all 256 grays are grouped into eight gray groups and the sizes of the gray groups, e.g., the number of grays included in each of the gray groups is equal to 32 (i.e., 8 groups×32 grays=256). In detail, the first gray group includes the 0-th to 31-th grays, the second gray group includes the 32-th to 63-th grays, the third gray group includes the 64-th to 95-th grays, the fourth gray group includes the 96-th to 127-th grays, the fifth gray group includes the 128-th to 159-th grays, the sixth gray group includes the 160-th to 191-th grays, the seventh gray group includes the 192-th to 223-th grays, and the eighth gray group includes the 224-th to 255-th grays. For example, the number of the normal image signals DNr, DNg and DNb for a frame is 100. Among the hundred normal image signals DNr, DNg and DNb, when two have grays belonging to the first gray group, five have grays belonging to the second gray group, eight have grays belonging to the third gray group, ten have grays belonging to the fourth gray group, forty have grays belonging to the fifth gray group, twenty have grays belonging to the sixth gray group, ten have grays belonging to the seventh gray group, and five have grays belonging to the eighth gray group, the counter 621, 631 or 641 selects the fifth gray group. Therefore, the signal averaging unit 622, 632 or 642 averages forty normal image signals DNr, DNg and DNb having the 128-th to 159-th grays.

Since the normal image signals DNr, DNg and DNb to be averaged to yield the average image signals DSr, DSg and DSb have small deviations, the white balance may be maintained.

The sample image signal generating unit 650 may generate the average image signals DSr, DSg and DSb based on the normal image signals DNr, DNg and DNb for the normal pixels PN disposed in a predetermined area of the display panel 300.

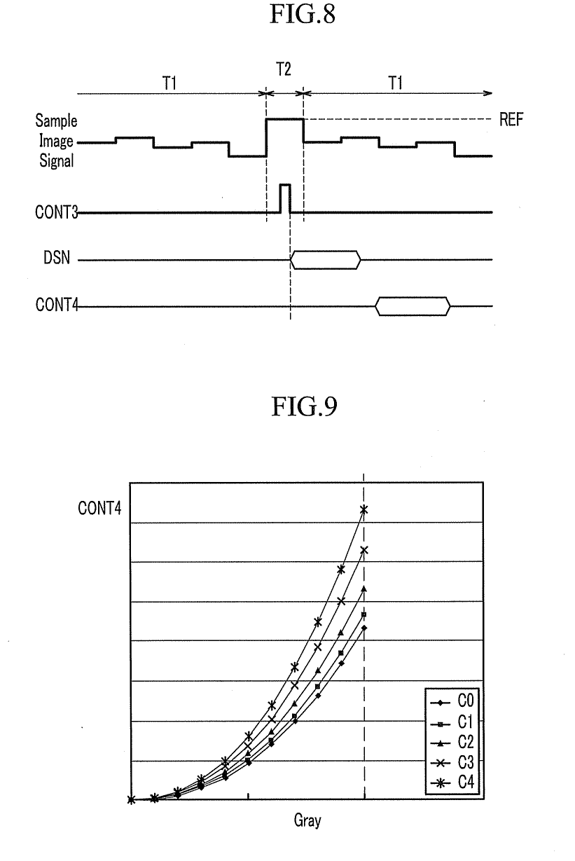

Now, an operation of the OLED display will be described in detail with reference to FIG. 8.

FIG. 8 shows waveforms of various signals used in an OLED display according to an exemplary embodiment of the present invention.

Referring to FIGS. 1-3 and 8, the signal controller 600 is supplied with input image signals R, G and B and input control signals for controlling the display thereof from an external graphics controller (not shown). The input image signals R, G and B include red input image signals R for red normal pixels, green input image signals G for green normal pixels, and blue input image signals B for blue normal pixels. The input image signals R, G and B contain luminance information of normal pixels PN and the luminance has a predetermined number of grays, for example, 1024(=2¹⁰), 256(=2⁸), or 64(=2⁶) grays. The input control signals include a vertical synchronization signal Vsync, a horizontal synchronization signal Hsync, a main clock signal MCLK and a data enable signal DE.

On the basis of the input control signals and the input image signals R, G and B, the signal controller 600 generates scanning control signals CONT1, data control signals CONT2, sensing control signals CONT3 and a gray control signal CONT4. The signal controller 600 processes the image signals R, G and B suitable for the operation of the display panel 300 and the data driver 500 to generate normal image signals DNr, DNg and DNb for the normal pixels PN. The signal controller 600 then averages the normal image signals DNr, DNg and DNb to generate average image signals DSr, DSg and DSb for the sample pixels PS. However, the average image signals DSr, DSg and DSb may be generated from the input mage signals R, G and B. The signal controller 600 further generates reference image signals REF (shown in FIG. 8) having a fixed gray for the sample pixels PS, and the reference image signals REF may have the highest gray. Hereinafter, the average image signals DSr, DSg and DSb and the reference image signals REF are commonly referred to as sample image signals, and the normal image signals DNr, DNg and DNb and the sample image signals are commonly referred to as output image signals DAT.

The signal controller 600 sends the scanning control signals CONT1 to the scanning driver 400, sends the output image signals DAT and the data control signals CONT2 to the data driver 500, sends the sensing control signals CONT3 to the sensing signal processor 800, and sends the gray control signal CONT4 to the gray voltage generator 550.

The scanning control signals CONT1 include a scanning start signal STV for instructing to start scanning and at least one clock signal for controlling the output period of the high voltage Von. The scanning control signals CONT1 may further include an output enable signal OE for defining the duration of the high voltage Von.

The data control signals CONT2 include a horizontal synchronization start signal STH for informing of a start of starting transmission of the output image signals DAT for a row of pixels PX, a load signal LOAD for instructing to apply analog data voltages to the data lines D₁-Dₘ₊₁, and a data clock signal HCLK.

The gray voltage generator 550 generates reference gray voltages GV based on the gray control signal CONT4 supplied from the signal controller 600.

Responsive to the data control signals CONT2 from the signal controller 600, the data driver 500 receives a packet of the digital output image signals DAT for the row of pixels PX from the signal controller 600, divides the reference gray voltages GV from the gray voltage generator 550 to generate analog data voltages corresponding to the digital output image signals DAT, and applies the analog data voltages to the data lines D₁-Dₘ₊₁. As described above, the data voltages include normal data voltages for the normal pixels PN and sample data voltages for the sample pixels PS.

The scanning driver 400 applies the high voltage Von to the scanning lines G₁-Gₙ₊₁ in response to the scanning control signals CONT1 from the signal controller 600, thereby turning on the switching elements Qs connected thereto. The data voltages applied to the data lines D₁-Dₘ₊₁ are then supplied to the pixels PX through the activated switching elements Qs.

The driving transistors Qd are supplied with the data voltages from the switching transistors Qs and generate output currents I_{LD} having a magnitude corresponding to the data voltages. The organic light emitting elements LD emit light having intensity depending on the output currents I_{LD} of the driving transistors Qd.

The above-described operation is repeatedly performed from the first row of the pixels PX to the last row of the pixels PX in order to display an image for a frame. Referring to FIG. 8, after the signal controller 600 supplies the average image signals DSr, DSg and DSb for a period T1 corresponding to several frames, the signal controller 600 supplies the reference images signals REF for a period T2 corresponding to a frame.

When the sample pixels PS emit light based on the reference image signals REF, the sensing units SU disposed near the sample pixels PS sense the luminance of the sample pixels PS and generate sensing signals SN having an analog current or an analog voltage depending on the sensed luminance of the sample pixels PS.

The sensing signal processor 800 reads the analog sensing signals SN, amplifies the analog sensing signals SN and analog-to-digital converts the analog sensing signals SN to generate digital sensing signals DSN.

The signal controller 600 modifies the gray control signal CONT4, which is supplied to the gray voltage generator 550, based on the digital sensing signals DSN from the sensing signal processor 800.

The gray voltage generator 550 modifies the values of the reference gray voltages GV based on the gray control signal CONT4 to adjust white balance and to compensate for the decrease of the luminance of the pixels PX due to the degradation of the organic light emitting elements LD and/or the driving transistors Qd.

Since the average image signals DSr, DSg and DSb are the averages of the normal image signals DNr, DNg and DNb, the decrease of the luminance of the sample pixels PS may be similar to that of the normal pixels PN and thus the compensation may be appropriate.

The above-described luminance sensing and gray voltage GV compensation is periodically performed to periodically compensate for the decrease of the luminance and for the break of the white balance.

An example of the gray control signal CONT4 will be described in more detail with reference to FIG. 9.

FIG. 9 is a graph illustrating a gray control signal CONT4 of an OLED display according to an exemplary embodiment of the present invention.

The graph shown in FIG. 9 illustrates several curves C0, C1, C2, C3 and C4 illustrating the gray control signal CONT4 as function of gray for different values of the digital sensing signal DSN. The graph may be stored in a lookup table.

The gray control signal CONT4 has a set of values denoted by symbols on the curves C0-C4 for given grays.

For example, the gray control signal CONT4 may have a set of values denoted by the lozenges on the curve C0 in the initial state. After a time elapses, if a digital sensing signal DSN informs that the luminance of the pixels PX has decreased, the signal controller 600 may change the gray control signal CONT4 from the curve C0 to the curve C1 such that the gray control signal CONT4 will have another set of values denoted by the squares corresponding to the lozenges on the curve C0 in the initial state, the values of the squares being larger than the values on the curve C0.

The curves C0-C4 are selected based on the digital sensing signal DSN, and the gray control signal CONT corresponding to other values of the digital sensing signal DSN may be calculated using interpolation.

The gray control signal CONT4 may have three sets of values corresponding to red, green and blue pixels, which may include organic light emitting elements LD having different emission efficiencies and different degrees of degradation.

Although exemplary embodiments of the present invention have been described in hereinabove, it should be clearly understood that many variations and/or modifications of the basic inventive concepts herein taught which may be apparent to those skilled in the present art will still fall within the spirit and scope of the present invention, as defined in the appended claims.

What is claimed is:

1. A display device comprising:
a plurality of pixels comprising normal pixels and sample pixels;
a plurality of sensing units which sense luminance of the sample pixels and generate sensing signals based on the sensed luminance;
a gray voltage generator which generates a plurality of reference gray voltages having values depending on the sensing signals; and
a data driver which generates normal data voltages for the normal pixels and sample data voltages for the sample pixels.

2. The display device of claim 1, further comprising a signal controller which generates normal image signals for the normal pixels and sample image signals for the sample pixels based on input image signals for the normal pixels and which controls the gray voltage generator,
wherein the data driver converts the normal image signals into the normal data voltages and the sample image signals into the sample data voltages.

3. The display device of claim 2, wherein the sample image signals comprise average image signals obtained by averaging the normal image signals and reference image signals having fixed values.

4. The display device of claim 3, wherein the signal controller comprises a signal averaging unit which averages the normal image signals to generate the average image signals.

5. The display device of claim 4, wherein the average image signals are obtained by averaging the normal image signals for a limited number of the normal pixels.

6. The display device of claim 5, wherein the average image signals are obtained by averaging the normal image signals having a predetermined range of grays.

7. The display device of claim 6, wherein total grays that can be represented by the normal image signals are grouped into a plurality of gray groups, the predetermined range of grays are included in one of the gray groups, and the number of the normal image signals representing grays in the one of the gray groups is equal to or larger than the number of the normal image signals having grays in each of other gray groups.

8. The display device of claim 7, wherein the signal controller further comprises a counter which counts the number of the normal image signals having grays in each of the gray groups.

9. The display device of claim 8, wherein the numbers of grays in at least two of the gray groups are different from each other.

10. The display device of claim 4, wherein the reference image signals are supplied to the data driver less frequently than the average image signals.

11. The display device of claim 10, further comprising a sensing signal processor which processes the sensing signals that represent the luminance of the sample pixels according to the reference image signals.

12. The display device of claim 11, wherein the signal controller generates a gray control signal determining values of the reference gray voltages based on an output of the sensing signal processor.

13. The display device of claim 12, wherein the signal controller further comprises a lookup table which stores the gray control signal as a function of the output of the sensing signal processor.

14. The display device of claim 12, wherein the sample pixels include three sample pixels which emit different-colored lights.

15. The display device of claim 14, wherein the three sample pixels are simultaneously supplied with the sample data voltages.

16. The display device of claim 14, wherein the three sample pixels are sequentially supplied with the sample data voltages from a single data line.

17. The display device of claim 1, wherein the normal pixels display images and the sample pixels do not participate in displaying images.

18. A method of driving a display device, the method comprising:
supplying normal data voltages to normal pixels to display an image;
supplying a first sample data voltage obtained from the normal data voltages to a sample pixel to emit light;
supplying a second sample data voltage having a fixed value to the sample pixel to emit light;
determining values of gray voltages based on a luminance of the sample pixel according to the second sample data voltage; and
generating the normal data voltages from the gray voltages.

19. The method of claim 18, wherein the supply of the first sample data voltage comprises:
averaging normal image signals to generate an average image signal;
converting the average image signal into the first sample data voltage; and
applying the first sample data voltage to the sample pixel,
wherein the normal data voltages are converted from the normal image signals.

20. The method of claim 13, wherein the determination of the values of the gray voltages comprises:
sensing the luminance of the sample pixel;
generating a sensing signal based on the sensed luminance of the sample pixel; and
determining the values of the gray voltages based on the sensing signal.

21. A display panel comprising:
a plurality of normal pixels for displaying images;
a plurality of sample pixels spaced apart from the normal pixels;
a plurality of sensing unit which sense luminance of the sample pixels,
a plurality of scanning lines connected to the normal pixels and the sample pixels; and
a plurality of data lines connected to the normal pixels and the sample pixels.

22. The display panel of claim 21, wherein the scanning lines comprise a plurality of normal scanning lines connected to the normal pixels and a sample scanning line connected to the sample pixels.

23. The display panel of claim 22, wherein the sample pixels are connected to different data lines.

24. The display panel of claim 21, wherein the data lines comprise a plurality of normal data lines connected to the normal pixels and a sample data line connected to the sample pixels.

25. The display panel of claim 21, wherein the normal pixels are disposed in a display area and the sample pixels are disposed outside of the display area.
